(19) United States
(12) Patent Application Publication
(10) Pub. No.: US 2017/0094413 A1
(43) Pub. Date: Mar. 30, 2017

(54) SOUNDBOARD SPEAKER OF DIGITAL PIANO

(71) Applicant: Kawai Musical Instruments Manufacturing Co., Ltd., Shizuoka (JP)

(72) Inventor: Takuya Satoh, Shizuoka (JP)

(21) Appl. No.: 15/240,035

(22) Filed: Aug. 18, 2016

(30) Foreign Application Priority Data
Sep. 29, 2015 (JP) 2015-191152
Sep. 29, 2015 (JP) 2015-191153

(51) Int. Cl. H04R 7/16; H04R 1/02; H04R 7/04

(52) U.S. Cl. CPC H04R 7/16; H04R 7/04; H04R 1/028

(57) ABSTRACT

To provide a soundboard speaker of a digital piano that displays more favorable acoustics by devising the arrangement of the vibration unit and ribs. In a soundboard speaker of a digital piano which transmits vibration generated by a vibration unit mounted at one face side of a diaphragm by ribs Ka to Kd mounted at the other face side of the diaphragm so that sound is produced from the whole of the diaphragm, the vibration unit disposed at a position to overlap the rib Kb when the soundboard speaker is viewed head on. The diaphragm in a horizontally long rectangular shape, and the ribs Ka to Kd consisting of prismatic members are disposed on the surface of the diaphragm parallel to each other and in an inclined manner with respect to the vertical direction.

### TECHNICAL FIELD

The present invention relates to a soundboard speaker of a digital piano, and particularly, to a soundboard speaker of a digital piano which produces sound from the whole of a tabular diaphragm by activating a vibration unit fixed to the diaphragm.

### BACKGROUND ART

Conventionally, a digital piano as an electronic keyboard musical instrument has been known that uses a soundboard speaker which reproduces the structure of a soundboard in an acoustic piano as a natural musical instrument. The soundboard speaker is a speaker which activates a vibration unit fixed to a large-sized diaphragm mounted to stand on a back face of the digital piano so as to produce sound from the whole of the diaphragm, and which allows obtaining the quality of sound close to that of an acoustic piano that transmits to a soundboard the vibration of a string stroke by a hammer working with the keyboard to produce sound from the whole of the soundboard.

Patent Literature 1 discloses a soundboard speaker for which a plurality of ribs made of a material excellent in vibration transmitting characteristics are mounted on the surface of a diaphragm and a vibration unit is mounted on the surface of the ribs.

### CITATION LIST

### Patent Literatures

Patent Literature 1: Japanese Utility Model Application Laid-open (JP-U) No. 55-26568

### SUMMARY OF INVENTION

### Technical Problem

However, with the constitution disclosed in Patent Literature 1, because the mounting position of the vibration unit is the surface of the ribs, vibration of the vibration unit is not easily transmitted from the ribs to the diaphragm, and there has been a possibility that the effect of the soundboard speaker is not sufficiently exhibited.

Also, regarding the structure of a soundboard speaker as in Patent Literature 1, the present inventor has revealed by repeating an experiment to sense vibration transmitted to the diaphragm by a sensor that the mounting position of the vibration unit and the arrangement of the ribs greatly affect the degree of transmission of vibration to the diaphragm. In this regard, with the constitution disclosed in Patent Literature 1, because the ribs are disposed by mutual coupling in a lattice pattern, there has been a possibility that vibrations of the vibration unit interfere with each other to prohibit sufficiently exhibiting the effect of the soundboard speaker.

An object of the present invention is to solve the problems of the conventional technique described above and provide a soundboard speaker of a digital piano that displays more favorable acoustics by devising the arrangement of a vibration unit and ribs.

### Solution to Problems

To achieve the afore-mentioned object, the present invention has a first feature in that a soundboard speaker (30) of a digital piano which transmits vibration generated by a vibration unit (32) mounted at one face side of a diaphragm (31) by ribs (Ka, Kb, Kc, Kd) mounted at the other face side of the diaphragm (31) so that sound is produced from the whole of the diaphragm (31), wherein, the vibration unit (32) is disposed at a position to overlap the rib (Kb) when the soundboard speaker (30) is viewed from the front.

The present invention has a second feature in that the diaphragm (31) is in a horizontally long rectangular shape, and the ribs (Ka, Kb, Kc, Kd) are a plurality of prismatic members, and disposed on a surface of the diaphragm (31) parallel to each other and in an inclined manner with respect to a vertical direction.

The present invention has a third feature in that the vibration unit (32) is provided solely for the diaphragm (31), and disposed in a manner offset to an upside and either a right or left side from a center of the diaphragm (31).

The present invention has a fourth feature in that the soundboard speaker (30) is disposed so that the vibration unit (32) is positioned at a front side of the digital piano (1).

The present invention has a fifth feature in that the vibration unit (32) includes a main body portion (40) and a vibrator (41), and the vibration unit (32) is mounted so that the vibrator (41) is brought into contact with a surface of the diaphragm (31).

The present invention has a sixth feature in that the vibration unit (32) includes a main body portion (40) and a vibrator (41), and the vibration unit (32) is mounted so that the vibrator (41) is engaged with an engagement hole (43) provided in the diaphragm (31).

The present invention has a seventh feature in that the vibration unit (32) is disposed at a position to overlap an axis of the rib (Kb) when the soundboard speaker (30) is viewed from the front.

The present invention has an eighth feature in that a soundboard speaker (30, 30A, 30B) of a digital piano which transmits vibration generated by a vibration unit (32) mounted at one face side of a diaphragm (31) by ribs (K1-K10, K11-K19, K20-K29) mounted at the other face side of the diaphragm (31) so that sound is produced from the whole of the diaphragm (31), wherein the ribs (K1-K10, K11-K19, K20-K29) are disposed in a radial form centered on the vibration unit (32) when the soundboard speaker (30, 30A, 30B) is viewed from the front.

The present invention has a ninth feature in that the ribs (K1-K10) are disposed so as not to overlap the vibration unit (32) when the soundboard speaker (30) is viewed from the front.

The present invention has a tenth feature in that the ribs (K11-K19, K20-K29) are disposed so as to overlap the vibration unit (32) when the soundboard speaker (30A, 30B) is viewed from the front.

The present invention has a eleventh feature in that the ribs (K1-K10) are disposed out of contact with each other.

The present invention has a twelfth feature in that the ribs (K11-K19, K20-K29) are coupled to each other.

The present invention has a thirteenth feature in that the vibration unit (32) is provided solely for the diaphragm (31), and disposed in a manner offset to an upside and either a right or left side from a center of the diaphragm (31).

The present invention has a fourteenth feature in that the soundboard speaker (30) is disposed so that the vibration unit (32) is positioned at a front side of the digital piano (1).

The present invention has a fifteenth feature in that the vibration unit (32) includes a main body portion (40) and a vibrator (41), and the vibration unit (32) is mounted so that the vibrator (41) is brought into contact with a surface of the diaphragm (31).

The present invention has a sixteenth feature in that the vibration unit (32) includes a main body portion (40) and a vibrator (41), and the vibration unit (32) is mounted so that the vibrator (41) is engaged with an engagement hole (43) provided in the diaphragm (31).

### Advantageous Effects of Invention

According to the first feature, the vibration unit (32) is disposed at a position to overlap the rib (Kb) when the soundboard speaker (30) is viewed from the front. Therefore, the effect of transmitting vibration by the ribs is sufficiently exhibited, besides direct transmission of the vibration of the vibration unit to the diaphragm. This makes it possible to further enhance the effect of producing a uniform sound from the whole of the diaphragm, as compared with the one in which a vibration unit is mounted on the surface of ribs or a conventional method in which a vibration unit is mounted to a diaphragm on the same face as with ribs.

According to the second feature, the diaphragm (31) is in a horizontally long rectangular shape, and the ribs (Ka, Kb, Kc, Kd) are a plurality of prismatic members, and disposed on a surface of the diaphragm (31) parallel to each other and in an inclined manner with respect to a vertical direction, which therefore makes it possible to arrange the vibration unit at a position where the vibration of the vibration unit is easily transmitted while securing the length of the ribs to make the speed for transmitting vibration to the adjacent ribs faster. Also, providing the ribs as prismatic members facilitates the production of the ribs and the mounting work thereof to the diaphragm.

According to the third feature, the vibration unit (32) is provided solely for the diaphragm (31), and disposed in a manner offset to an upside and either a right or left side from a center of the diaphragm (31), which therefore makes it possible to avoid a louder sound from being produced in a part of the range than in other parts to prohibit obtaining a desired sound pressure when the vibration unit is disposed in the center of the diaphragm and to avoid a large amplitude from not being able to be provided to the diaphragm when the vibration unit is disposed at an off-center position to a corner of the diaphragm, so as to enhance the acoustics by the soundboard speaker.

According to the fourth feature, the soundboard speaker (30) is disposed so that the vibration unit (32) is positioned at a front side of the digital piano (1). Therefore, the vibration unit is not exposed at a back face side of the digital piano, which makes it possible to improve the external appearance of the digital piano.

According to the fifth feature, the vibration unit (32) includes a main body portion (40) and a vibrator (41), and the vibration unit (32) is mounted so that the vibrator (41) is brought into contact with a surface of the diaphragm (31), which therefore makes it possible to efficiently transmit vibration generated by the vibrator to the diaphragm.

According to the sixth feature, the vibration unit (32) includes a main body portion (40) and a vibrator (41), and the vibration unit (32) is mounted so that the vibrator (41) is engaged with an engagement hole (43) provided in the diaphragm (31), which therefore makes it possible to even more efficiently transmit vibration generated by the vibrator to the diaphragm and reduce the thickness dimension of the whole soundboard speaker by an extent to which the vibrator is embedded.

According to the seventh feature, the vibration unit (32) is disposed at a position to overlap an axis of the rib (Kb) when the soundboard speaker (30) is viewed from the front, which therefore makes it possible to transmit vibration of the vibration unit from the center of the rib evenly to the right and left.

According to the eighth feature, the ribs (K1-K10, K11-K19, K20-K29) are disposed in a radial form centered on the vibration unit (32) when the soundboard speaker (30, 30A, 30B) is viewed from the front. Therefore, along with the fact that the vibration of the vibration unit is transmitted in a radial manner along the diaphragm, disposing ribs having a fast vibration transmission speed along the transmission direction of vibration makes it possible to further enhance the effect of transmitting vibration by the ribs. This makes it possible to further enhance the effect of producing a uniform sound from the whole of the diaphragm.

According to the ninth feature, the ribs (K1-K10) are disposed so as not to overlap the vibration unit (32) when the soundboard speaker (30) is viewed from the front, which therefore facilitates disposing a plurality of ribs in a radial form centered on the vibration unit.

According to the tenth feature, the ribs (K11-K19, K20-K29) are disposed so as to overlap the vibration unit (32) when the soundboard speaker (30A, 30B) is viewed from the front. Therefore, the effect of transmitting vibration by the ribs is sufficiently exhibited, besides direct transmission of the vibration of the vibration unit to the diaphragm. This makes it possible to further enhance the effect of producing a uniform sound from the whole of the diaphragm, as compared with the one in which a vibration unit is mounted on the surface of ribs or a conventional method in which a vibration unit is mounted to a diaphragm on the same face as with ribs.

According to the eleventh feature, the ribs (K1-K10) are disposed out of contact with each other, which therefore facilitates disposing a plurality of ribs in a radial form centered on the vibration unit. Also, the possibility that vibrations transmitted to the ribs interfere with each other can be reduced to stably obtain an effect of producing a uniform sound from the whole of the diaphragm.

According to the twelfth feature, the ribs (K11-K19, K20-K29) are coupled to each other which therefore makes it possible to construct a plurality of ribs as an integrated part so as to achieve a reduction in cost and weight.

According to the thirteenth feature, the vibration unit is provided solely for the diaphragm (31), and disposed in a manner offset to an upside and either a right or left side from a center of the diaphragm (31), which therefore makes it possible to avoid a louder sound from being produced in a part of the range than in other parts to prohibit obtaining a desired sound pressure when the vibration unit (32) is disposed in the center of the diaphragm and to avoid a large amplitude from not being able to be provided to the diaphragm when the vibration unit is disposed at an off-center position to a corner of the diaphragm, so as to enhance the acoustics by the soundboard speaker.

According to the fourteenth feature, the soundboard speaker (30) is disposed so that the vibration unit (32) is positioned at a front side of the digital piano (1). Therefore, the vibration unit is not exposed at a back face side of the digital piano, which makes it possible to improve the external appearance of the digital piano.

According to the fifteenth feature, the vibration unit (32) includes a main body portion (40) and a vibrator (41), and the vibration unit (32) is mounted so that the vibrator (41) is brought into contact with a surface of the diaphragm (31), which therefore makes it possible to efficiently transmit vibration generated by the vibrator to the diaphragm.

According to the sixteenth feature, the vibration unit (32) includes a main body portion (40) and a vibrator (41), and the vibration unit (32) is mounted so that the vibrator (41) is engaged with an engagement hole (43) provided in the diaphragm (31), which therefore makes it possible to even more efficiently transmit vibration generated by the vibrator to the diaphragm and reduce the thickness dimension of the whole soundboard speaker by an extent to which the vibrator is embedded.

### BRIEF DESCRIPTION OF DRAWINGS

FIG. 1 is a perspective view of a digital piano according to the present embodiment.

FIG. 2 is a back view of the digital piano

FIG. 3 is a right side view of the digital piano.

FIG. 4 is a front view of the soundboard speaker.

FIG. 5 is a sectional view taken along a line 5-5 in FIG. 4.

FIG. 6 is a sectional view showing a modification of a mounting structure of the vibration unit.

FIG. 7 is a back view of a digital piano according to a second embodiment of the present invention.

FIG. 8 is a front view of the soundboard speaker.

FIG. 9 is a sectional view taken along a line 9-9 in FIG. 8.

FIG. 10 is a front view of a soundboard speaker according to a third embodiment of the present invention.

FIG. 11 is a front view of a soundboard speaker according to a modification of the third embodiment of the present invention.

FIG. 12 is a sectional view taken along a line 12-12 in FIG. 11.

### DESCRIPTION OF EMBODIMENTS

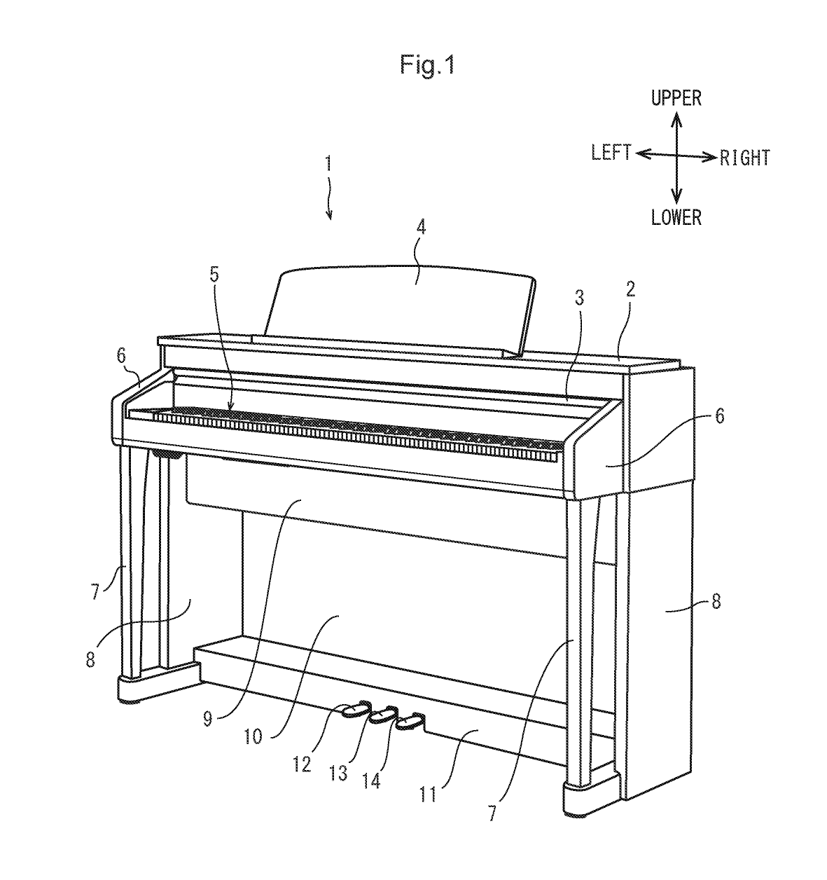

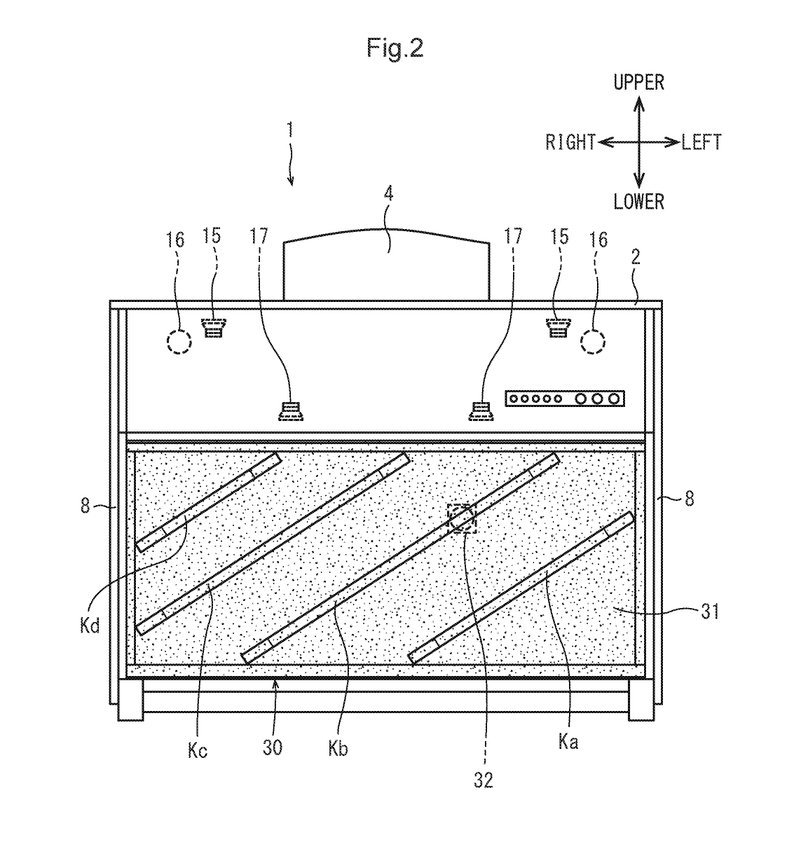

Hereinafter, preferred embodiments of the present invention will be described in detail with reference to the drawings. FIG. 1 is a perspective view of a digital piano 1 applied with a soundboard speaker 30 (refer to FIG. 2) according to the present embodiment. The directional arrows in the figure indicate UP, DOWN, LEFT, and RIGHT with the player side set as the front. The digital piano 1 is an electronic keyboard musical instrument that detects a key depression state of a keyboard 15 by a sensor switch, generates a musical sound signal by arithmetically processing the detection result, and sounds the same by a plurality of speakers equipped in a main body. For the digital piano 1 according to the present embodiment, the soundboard speaker 30 is applied to one of the plurality of speakers that takes charge of a low-pitch range, and this speaker is arranged at a back face portion of the piano main body.

Upper portions of a pair of right and left side boards 8 are coupled by a top board 2, and arms 6 are mounted in a projecting manner from the side boards 8 to the player side. A keyboard 5 is provided between the pair of right and left arms 6, and thereover a sliding key cover 3 is provided. A music stand 4 is mounted to the top board 2, and a pair of right and left legs 7 are mounted to lower front portions of the arms 6.

A front board 10 is disposed between the right and left side boards 8, and in a lower portion of the front board 10, a pedal base 11 including pedals 12, 13, and 14 is disposed. The pedals 12, 13, and 14 can be provided as a soft pedal, a muffler pedal, and a damper pedal, respectively. A speaker box 9 is disposed under and behind the keyboard 5, and the soundboard speaker 30 according to the present embodiment is disposed on a back face side of the front board 10. In a bottom portion of the speaker box 9, a hole to output sound of the soundboard speaker 30 from the front is provided so that an output sound of the soundboard speaker 30 is actively output not only from the back face side but also the front face side of the digital piano 1.

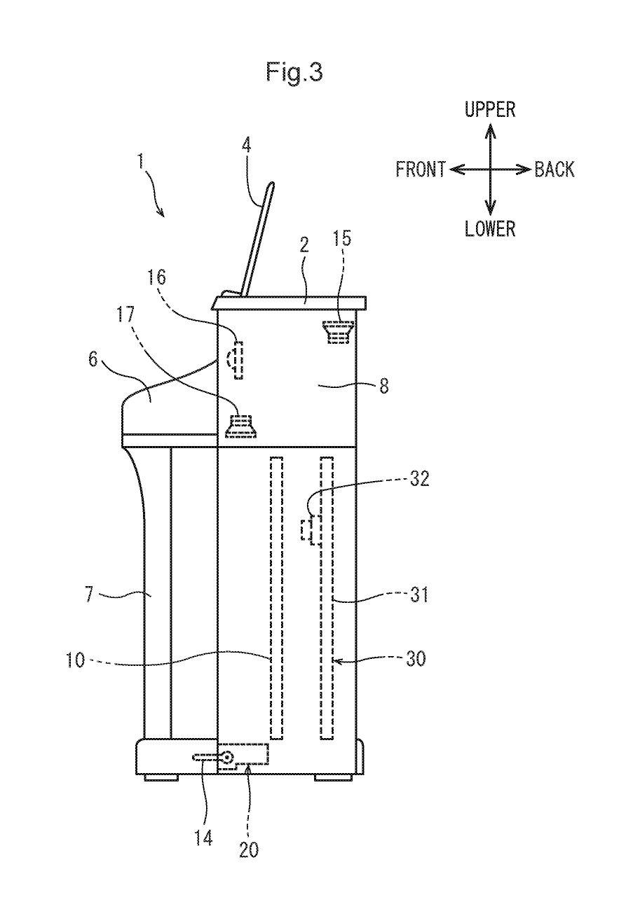

FIG. 2 is a back view of the digital piano 1, and FIG. 3 is a right side view of the digital piano 1. In the digital piano 1, a pair of right and left high range speakers 16 oriented forward, a pair of right and left mid-high range speakers 15 oriented upward, a pair of right and left mid-high range speakers 17 oriented downward, and the soundboard speaker 30 that vibrates at a frequency suitable for producing a low-range musical sound are provided. The high range speakers 16 can be provided as, for example, 2-cm dome tweeters, and the mid-high range speakers 15 and 17 can be provided as, for example, 7-cm full range speakers. The three pedals 12, 13, and 14 are axially supported so as to be freely swingable with respect to a pedal unit 20, and produce acoustic effects according to a pedal operation sensed by a sensor.

The soundboard speaker 30 is mounted behind the front board 10 so that a quadrate diaphragm 31 is exposed to the back face of the digital piano 1. At a back face side of the diaphragm 31, four ribs Ka, Kb, Kc, and Kd are mounted, and a vibration unit 32 for vibrating the diaphragm 31 is mounted at a front face side of the diaphragm 31.

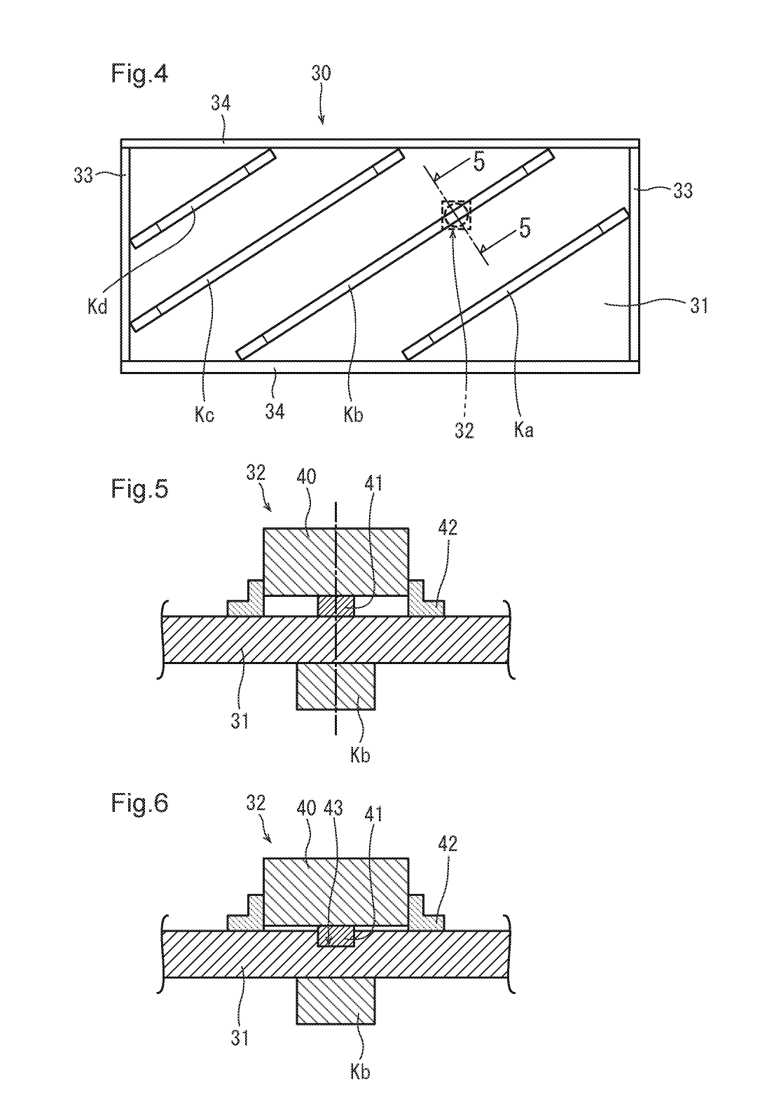

FIG. 4 is a front view of the soundboard speaker 30. The diaphragm (soundboard) 31 being in a horizontally long rectangular shape is made by, for example, 6 mm-thick spruce plywood, and at four sides thereof, prism-shaped frame members 33 and 34 are mounted.

The ribs Ka to Kd are made of a solid wood that is faster in vibration transmission speed than plywood, and has a function of quickly transmitting vibration of the vibration unit 32 to the whole of the diaphragm 31 and a function of providing desired strength to the soundboard speaker 30. The straight prism-shaped ribs Ka to Kd having respectively different overall lengths are arranged, parallel to each other and at respectively different intervals, so that their opposite end portions approximate the frame members 33 and 34. The ribs Ka to Kd are respectively fixed to the diaphragm 31 by adhesive. On the side of the diaphragm 31, grooves into which the adhesive is made to flow are formed, and the respective end portions of the ribs Ka to Kd are reduced in weight by being gradually reduced in thickness at a part having a weaker vibration transmission function.

In the present embodiment, arranging the ribs Ka to Kd parallel to each other and in an inclined manner with respect to the vertical direction makes it possible to arrange the vibration unit 32 at a position where the vibration of the vibration unit 32 is easily transmitted while securing the length of the ribs Ka to Kd to make the speed for transmitting vibration to the adjacent ribs faster. Moreover, providing the ribs as prismatic members also facilitates the production of the ribs and the mounting work thereof to the diaphragm.

The vibration unit 32 is mounted to a face opposite to a face to which the ribs Ka to Kd are mounted. Further, the present invention is characterized in that the vibration unit 32 is mounted at a position to overlap the rib Kb in a front view of the soundboard speaker 30, in other words, when the diaphragm 31 is viewed from its planar side. According to this constitution, the effect of transmitting vibration by the ribs Ka to Kd is sufficiently exhibited, besides direct transmission of the vibration of the vibration unit 32 to the diaphragm 31. This makes it possible to further enhance the effect of producing a uniform sound from the whole of the diaphragm 31, as compared with the one in which a vibration unit is mounted on the surface of ribs or a conventional method in which a vibration unit is mounted to a diaphragm on the same face as with ribs.

In addition, the position of the vibration unit, the number, the interval and angle of arrangement of ribs, etc., can be variously modified according to the material and dimensions of the soundboard and ribs, the vibration unit output, etc. According to a long-term experiment by the present inventor, it has been revealed that there is a tendency, regarding the position of the vibration unit, that disposing the same in the center of the diaphragm causes a louder sound produced in a part of the range than in other parts to prohibit obtaining a desired sound pressure, whereas at an off-center position to a corner, a large amplitude cannot be provided to the diaphragm, and it is therefore preferable, in the diaphragm having a horizontally long rectangular shape, to provide the vibration unit at a position slightly offset sideways and the up-down direction from its central portion.

In this regard, it has also been derived from experimentation to arrange the four ribs Ka to Kd having different lengths in an inclined manner, and in the present embodiment, as a result of selecting a position where the rib and vibration unit are respectively at optimal positions and both overlap each other, a position overlapping the axis of the rib Kb is determined. Arrangement at this position overlapping the axis of the rib Kb allows the vibration of the vibration unit 32 to be easily transmitted from the center of the rib evenly to the right and left.

FIG. 5 is a sectional view taken along a line 5-5 in FIG. 4. The vibration unit 32 provided as a voice coil type or a piezoelectric element type is made up of a main body portion 40, a vibrator 41, and a case portion 42 for fixing the main body portion 40 to the diaphragm 31. In the illustrated example, the case portion 42 supporting the main body portion 40 is mounted on the diaphragm 31 by a screw or the like so that the vibrator 41 abuts against the surface of the diaphragm 31.

FIG. 6 is a sectional view showing a modification of a mounting structure of the vibration unit 32. In the present modification, an engagement hole 43 with which the vibrator 41 is engaged is formed in the surface of the diaphragm 31 and the case portion 42 is fixed so that the vibrator 41 is engaged with the engagement hole 43. The engagement hole 43 can be formed by, for example, a 2 mm-deep cylindrical counterbore.

This constitution allows even more easily transmitting the vibration of the vibrator 41 to the diaphragm 31, and makes it also possible to reduce the thickness of the soundboard speaker 30. Further, filling a gap between the vibrator 41 and the engagement hole 43 with, for example, an epoxy resin-based adhesive allows preventing the generation of chattering noise due to the gap to further enhance the acoustics of the soundboard speaker 30.

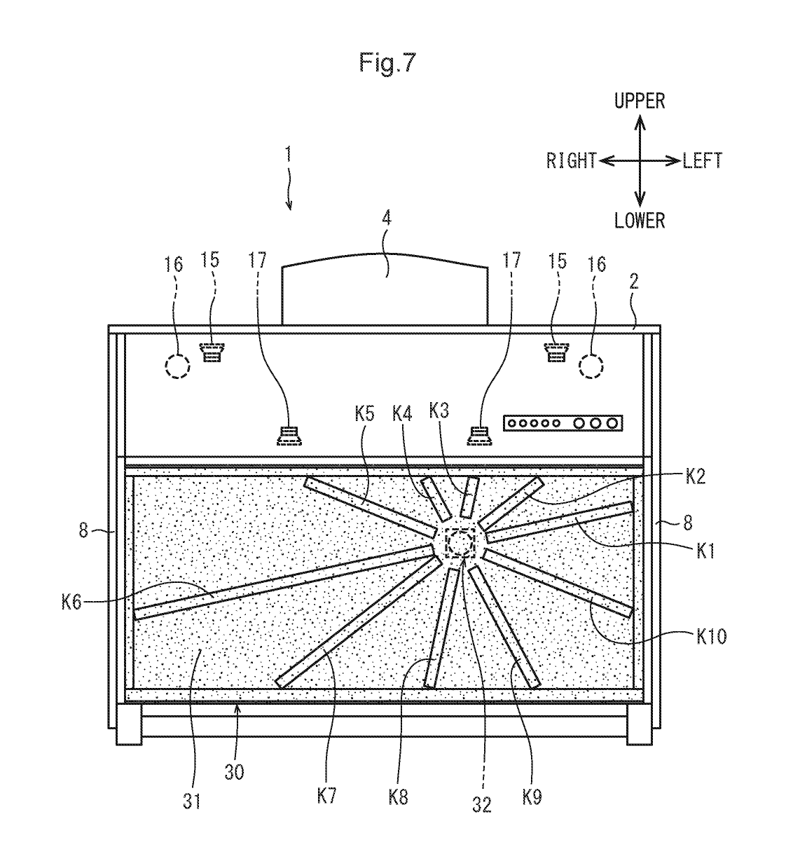

FIG. 7 is a back view of a digital piano 1 according to a second embodiment of the present invention. In the digital piano 1, a pair of right and left high range speakers 16 oriented forward, a pair of right and left mid-high range speakers 15 oriented upward, a pair of right and left mid-high range speakers 17 oriented downward, and the soundboard speaker 30 that vibrates at a frequency suitable for producing a low-range musical sound are provided. The high range speakers 16 can be provided as, for example, 2-cm dome tweeters, and the mid-high range speakers 16 and 17 can be provided as, for example, 7-cm full range speakers. The three pedals 12, 13, and 14 are axially supported so as to be freely swingable with respect to a pedal unit 20, and produce acoustic effects according to a pedal operation sensed by a sensor.

The soundboard speaker 30 is mounted behind the front board 10 so that a quadrate diaphragm 31 is exposed to the back face of the digital piano 1. At a back face side of the diaphragm 31, ten ribs K1, K2, K3, K4, K5, K6, K7, K8, K9, and K10 are mounted, and a vibration unit 32 for vibrating the diaphragm 31 is mounted at a front face side of the diaphragm 31.

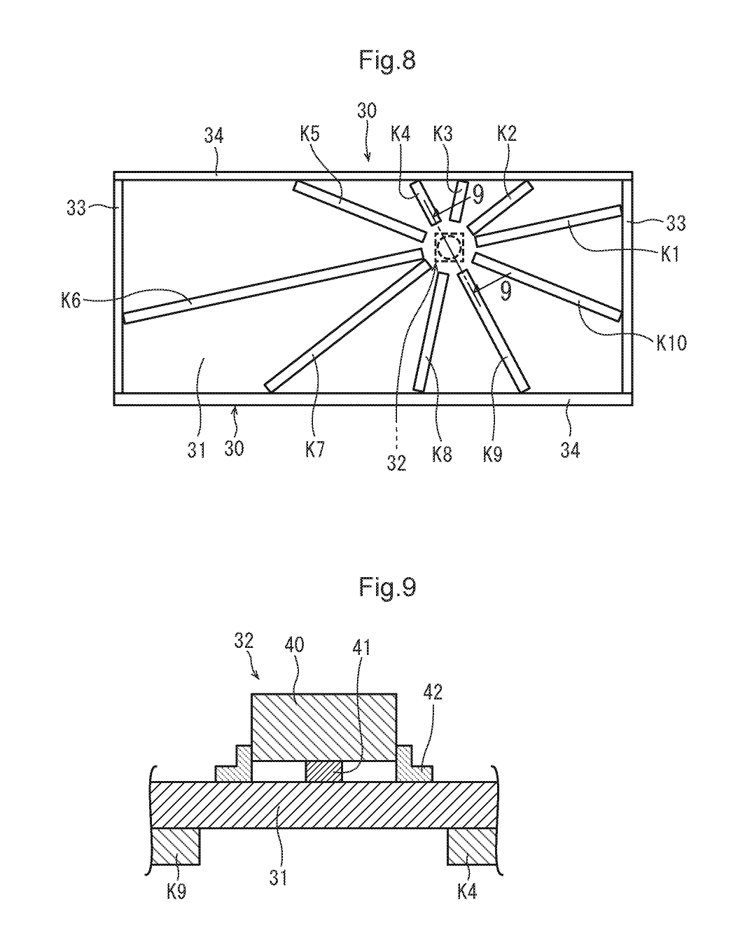

FIG. 8 is a front view of the soundboard speaker 30. The diaphragm (soundboard) 31 being in a horizontally long rectangular shape is made by, for example, 6 mm-thick spruce plywood, and at four sides thereof, prism-shaped frame members 33 and 34 are mounted.

The ribs K1 to K10 are made of a solid wood that is faster in vibration transmission speed than plywood, and has a function of quickly transmitting vibration of the vibration unit 32 to the whole of the diaphragm 31 and a function of providing desired strength to the soundboard speaker 30.

The straight prism-shaped ribs K1 to K10 having respectively different overall lengths are arranged in a radial form centered on the vibration unit 32 and so that their outer end portions approximate the frame members 33 and 34. According to an experiment by the present inventor, vibration generated by the vibration unit 32 is transmitted in a radial manner from its center along the diaphragm 31. The present invention, by disposing ribs having a fast vibration transmission speed along the transmission direction of vibration, further enhances the effect of vibration transmission by the ribs.

In the present second embodiment, no ribs are installed, in a front view of the soundboard speaker 30, at a center position to overlap the vibration unit 32, but inner end portions of the ribs are arranged so as to surround the vibration unit 32 to thereby form a radial form centered on the vibration unit 32. The ribs K1 to K10 are respectively fixed to the diaphragm 31 by adhesive. On the side of the diaphragm 31, grooves into which the adhesive is made to flow are formed, and the respective outer end portions of the ribs K1 to K10 can be reduced in weight by being gradually reduced in thickness at a part having a weaker vibration transmission function.

In addition, the position of the vibration unit, the number, the interval and angle of arrangement of ribs, etc., can be variously modified according to the material and dimensions of the soundboard and ribs, the vibration unit output, etc. According to a long-term experiment by the present inventor, it has been revealed that there is a tendency, regarding the position of the vibration unit, that disposing the same in the center of the diaphragm causes a louder sound produced in a part of the range than in other parts to prohibit obtaining a desired sound pressure, whereas at an off-center position to a corner, a large amplitude cannot be provided to the diaphragm, and it is therefore preferable, in the diaphragm having a horizontally long rectangular shape, to provide the vibration unit at a position slightly offset sideways and in the up-down direction from its central portion.

FIG. 9 is a sectional view taken along a line 9-9 in FIG. 8. The vibration unit 32 provided as a voice coil type or a piezoelectric element type is made up of a main body portion 40, a vibrator 41, and a case portion 42 for fixing the main body portion 40 to the diaphragm 31. In the illustrated example, the case portion 42 supporting the main body portion 40 is mounted on the diaphragm 31 by a screw or the like so that the vibrator 41 abuts against the surface of the diaphragm 31.

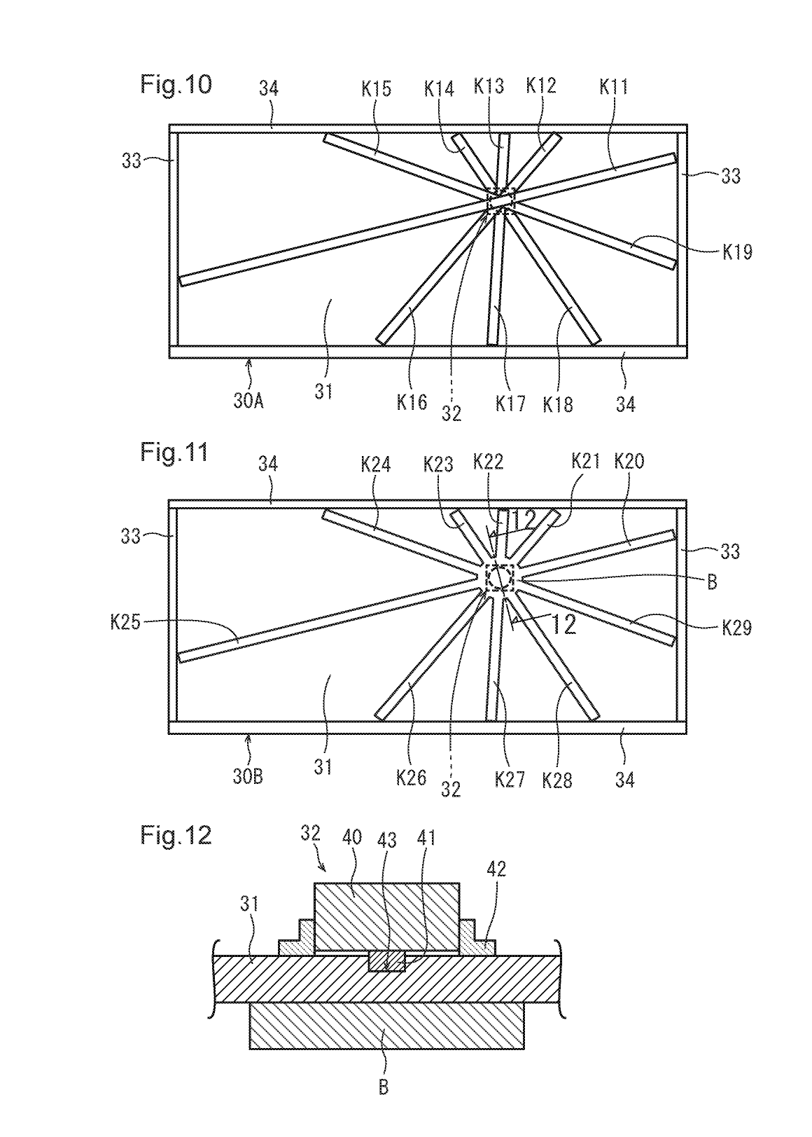

FIG. 10 is a front view of a soundboard speaker 30A according to a third embodiment of the present invention. The present embodiment is characterized in a constitution that, when arranging ribs in a radial form, the vibration unit 32 and the ribs have an overlapping part in a front view of the soundboard speaker 30A and all ribs are coupled to the part to overlap the vibration unit 32.

The ribs according to the present embodiment consist of a total of nine ribs K11 to K19. Specifically, by arranging the long rib Ku 1 and then combining the independent ribs K11 to K19 like parquetry work, an arrangement as if a total of five long members were overlapped centered on the vibration unit 32 is realized.

The vibration unit 32 is mounted to a face opposite to a face to which the ribs K11 to K19 are mounted, and further, in the present embodiment, the vibration unit 32 is mounted at a position to overlap the center of the ribs K11 to K19 in a front view of the soundboard speaker 30, in other words, when the diaphragm 31 is viewed from its planar side. According to this constitution, the effect of transmitting vibration by the ribs K12 to K19 is sufficiently exhibited, besides direct transmission of the vibration of the vibration unit 32 to the diaphragm 31, which makes it possible to further enhance the effect of producing a uniform sound from the whole of the diaphragm 31.

FIG. 11 is a front view of a soundboard speaker 30B according to a modification of the third embodiment of the present invention. The present modification is characterized in that not only a disk-shaped base part B is provided in a part to overlap the vibration unit 32, but all ribs K20 to K29 are also coupled to the base part B. At this time, constructing the base part B and the ribs K20 to K29 as an integral part facilitates the work for mounting the ribs on the diaphragm. Further, in the case of constructing the base part B and the ribs K20 to K29 as an integral part, a reduction in cost and weight can be achieved by employing integral molding of a synthetic resin, besides wood machining.

FIG. 12 is a sectional view taken along a line 12-12 in FIG. 11. In the present modification, an engagement hole 43 with which the vibrator 41 is engaged is formed in the surface of the diaphragm 31 and the case portion 42 is fixed so that the vibrator 41 is engaged with the engagement hole 43. The engagement hole 43 can be formed by, for example, a 2 mm-deep cylindrical counterbore.

This constitution allows even more easily transmitting the vibration of the vibrator 41 to the diaphragm 31, and makes it also possible to reduce the thickness of the soundboard speaker 30. Further, filling a gap between the vibrator 41 and the engagement hole 43 with, for example, an epoxy resin-based adhesive allows preventing the generation of chattering noise due to the gap to further enhance the acoustics of the soundboard speaker 30.

In addition, the structure and mode of the digital piano, the dimensions and structure of the soundboard speaker, the dimensions and material of the diaphragm, the shape and arrangement of the ribs, the structure and arrangement of the vibration unit, etc., are not limited to those of the embodiments described above, and can be variously modified. For example, the ribs may be in such a shape that linear ribs radially extend from an annular-shaped base part formed so as to surround a vibration unit. Alternatively, there may also be a constitution that some of the plurality of ribs are coupled to each other, and other ribs are separated from each other.

### REFERENCE SIGNS LIST

1 . . . digital piano,
2 . . . top board,
5 . . . keyboard,
6 . . . arm,
8 . . . side board,
10 . . . front board,
16 . . . high range speaker,
15, 17 . . . mid-high range speaker,
30 . . . soundboard speaker,
31 . . . diaphragm (soundboard),
32 . . . vibration unit,
33, 34 . . . frame member,
40 . . . main body portion,
41 . . . vibrator,
43 . . . engagement hole,
Ka, Kb, Kc, Kd . . . rib,
K1˜K10, K11˜K19, K20˜K29 . . . rib,
B . . . base part

1. A soundboard speaker of a digital piano which transmits vibration generated by a vibration unit mounted at one face side of a diaphragm by ribs mounted at the other face side of the diaphragm so that sound is produced from the whole of the diaphragm, wherein
the vibration unit is disposed at a position to overlap the rib when the soundboard speaker is viewed from the front.

2. The soundboard speaker of a digital piano according to claim 1, wherein the diaphragm is in a horizontally long rectangular shape, and
the ribs are a plurality of prismatic members, and disposed on a surface of the diaphragm parallel to each other and in an inclined manner with respect to a vertical direction.

3. The soundboard speaker of a digital piano according to claim 2, wherein the vibration unit is provided solely for the diaphragm, and disposed in a manner offset to an upside and either a right or left side from a center of the diaphragm.

4. The soundboard speaker of a digital piano according to claim 1, wherein the soundboard speaker is disposed so that the vibration unit is positioned at a front side of the digital piano.

5. The soundboard speaker of a digital piano according to claim 1, wherein the vibration unit includes a main body portion and a vibrator, and
the vibration unit is mounted so that the vibrator is brought into contact with a surface of the diaphragm.

6. The soundboard speaker of a digital piano according to claim 1, wherein the vibration unit includes a main body portion and a vibrator, and
the vibration unit is mounted so that the vibrator is engaged with an engagement hole provided in the diaphragm.

7. The soundboard speaker of a digital piano according to claim 1, wherein the vibration unit is disposed at a position to overlap an axis of the rib when the soundboard speaker is viewed from the front.

8. A soundboard speaker of a digital piano which transmits vibration generated by a vibration unit mounted at one face side of a diaphragm by ribs mounted at the other face side of the diaphragm so that sound is produced from the whole of the diaphragm, wherein
the ribs are disposed in a radial form centered on the vibration unit when the soundboard speaker is viewed from the front.

9. The soundboard speaker of a digital piano according to claim 8, wherein the ribs are disposed so as not to overlap the vibration unit when the soundboard speaker is viewed from the front.

10. The soundboard speaker of a digital piano according to claim 8, wherein the ribs are disposed so as to overlap the vibration unit when the soundboard speaker is viewed from the front.

11. The soundboard speaker of a digital piano according to claim 9, wherein the ribs are disposed out of contact with each other.

12. The soundboard speaker of a digital piano according to claim 9, wherein the ribs are coupled to each other.

13. The soundboard speaker of a digital piano according to claim 8, wherein the vibration unit is provided solely for the diaphragm, and disposed in a manner offset to an upside and either a right or left side from a center of the diaphragm.

14. The soundboard speaker of a digital piano according to claim 8, wherein the soundboard speaker is disposed so that the vibration unit is positioned at a front side of the digital piano.

15. The soundboard speaker of a digital piano according to claim 8, wherein the vibration unit includes a main body portion and a vibrator, and
the vibration unit is mounted so that the vibrator is brought into contact with a surface of the diaphragm.

16. The soundboard speaker of a digital piano according to claim 8, wherein the vibration unit includes a main body portion and a vibrator, and
the vibration unit is mounted so that the vibrator is engaged with an engagement hole provided in the diaphragm.

17. The soundboard speaker of a digital piano according to claim 2, wherein the soundboard speaker is disposed so that the vibration unit is positioned at a front side of the digital piano.

18. The soundboard speaker of a digital piano according to claim 2, wherein the vibration unit includes a main body portion and a vibrator, and
the vibration unit is mounted so that the vibrator is brought into contact with a surface of the diaphragm.

19. The soundboard speaker of a digital piano according to claim 2, wherein the vibration unit includes a main body portion and a vibrator, and
the vibration unit is mounted so that the vibrator is engaged with an engagement hole provided in the diaphragm.

20. The soundboard speaker of a digital piano according to claim 2, wherein the vibration unit is disposed at a position to overlap an axis of the rib when the soundboard speaker is viewed from the front.
